(19) United States
(12) Patent Application Publication
(10) Pub. No.: US 2019/0040837 A1
(43) Pub. Date: Feb. 7, 2019

(54) SYSTEMS AND METHODS OF CONTROLLING PRE-PRIMARY IGNITION OF AN INTERNAL COMBUSTION ENGINE

(71) Applicant: GM Global Technology Operations LLC, Detroit, MI (US)

(72) Inventors: Hanho Yun, Oakland Township, MI (US); Cherian A. Idicheria, Novi, MI (US); Paul M. Najt, Bloomfield Hills, MI (US)

(73) Assignee: GM Global Technology Operations LLC, Detroit, MI (US)

(21) Appl. No.: 16/074,802

(22) PCT Filed: Feb. 23, 2016
(86) PCT No.: PCT/US2016/019118

§ 371 Date: Aug. 2, 2018

(51) Int. Cl. F02P 5/15; F02P 9/00; F02M 26/47; F02P 15/08

(52) U.S. Cl. CPC F02P 5/1516; F02P 15/08; F02M 26/47; F02P 9/002

(57) ABSTRACT

A method of controlling pre-primary ignitions of an internal combustion engine includes accessing data corresponding to an exhaust gas recirculation error and data corresponding to at least one of a rotational speed of the engine, a throttle position of a throttle, and a combustion mode of the engine. A voltage of the electrical power to be applied to an ignition source and a number of pre-primary ignitions to be applied are calculated based on the data corresponding to the exhaust gas recirculation error and the data corresponding to at least one of the rotational speed of the engine, the throttle position, and the combustion mode of the engine.

### TECHNICAL FIELD

The disclosure generally relates to systems and methods of controlling pre-ignitions in a combustion chamber of an engine.

### BACKGROUND

Exhaust gas recirculation (“EGR”) is often utilized to reduce nitrogen oxide (“NOₓ”) emissions in internal combustion engines. However, in gasoline engines at low transient operating temperatures, EGR may result in misfire or abrupt combustion in the combustion chambers, i.e., the cylinders. As such, the gasoline engine may become unstable and produce excess noise during transient, low temperature operation.

### SUMMARY

In one embodiment, the method of controlling pre-primary ignition of an internal combustion engine utilizes a controller. The engine includes a combustion chamber and an ignition source for igniting fuel in the combustion chamber. The method includes accessing data corresponding to an exhaust gas recirculation error and accessing data corresponding to at least one of a rotational speed of the engine, a fuel mass quantity injected into the combustion chamber, a throttle position of a throttle, and a combustion mode of the engine. The method also includes calculating a voltage of the electrical power to be applied to the ignition source based on the data corresponding to the exhaust gas recirculation error and the data corresponding to at least one of the rotational speed of the engine, a fuel mass quantity injected into the combustion chamber, the throttle position, and the combustion mode of the engine. The method further includes applying electrical power at the calculated voltage to the ignition source to produce at least one pre-primary ignition.

In one exemplary embodiment, the method of controlling pre-primary ignition of an internal combustion engine utilizes a controller. The engine includes a combustion chamber and an ignition source for igniting fuel in the combustion chamber. The method includes accessing data corresponding to an exhaust gas recirculation error and accessing data corresponding to at least one of a rotational speed of the engine, a throttle position of a throttle, and a combustion mode of the engine. The method further includes calculating a number of pre-primary ignitions to be applied based on the exhaust gas recirculation error. The method also includes applying electrical power to the ignition source in accordance with the number of pre-primary ignitions to be applied.

In one exemplary embodiment, a vehicle includes an engine having a combustion chamber defining an inlet and an outlet. The engine also includes an ignition source for initiating pre-primary ignition in the combustion chamber. An exhaust recirculation passage fluidly connects the outlet to the inlet with an exhaust recirculation valve for controlling flow of exhaust gas from the outlet to the inlet. The engine also includes a flow sensor for sensing a flow rate of exhaust gas through the exhaust recirculation passage. A speed sensor senses the rotational speed of the engine and a throttle position sensor senses a throttle position of the engine. The vehicle further includes a controller in communication with the sensors for receiving data corresponding to the flow rate of exhaust gas through the exhaust recirculation passage, a fuel mass quantity injected into the combustion chamber, the rotational speed of the engine, and the throttle position of the engine. The controller is in communication with the exhaust recirculation valve to control operation of the exhaust recirculation valve according to a desired exhaust recirculation flow rate. The controller is also configured to compute an exhaust gas recirculation error based on the desired exhaust recirculation flow rate and the sensed flow rate of exhaust gas. The controller is further configured to determine the combustion mode of the engine. The controller is also configured to calculate a voltage of the electrical power to be applied to the ignition source based on the data corresponding to the exhaust gas recirculation error and the data corresponding to at least one of the rotational speed of the engine, a fuel mass quantity injected into the combustion chamber, the throttle position, and the combustion mode of the engine. The vehicle also includes a power regulating circuit in communication with the controller and electrically connected to the ignition source to apply electrical power at the calculated voltage to the ignition source to produce a pre-primary ignition.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a block diagram of a vehicle having an engine with a system for controlling ignition of the engine according to one exemplary embodiment;

FIG. 2 is a schematic diagram representing a combustion chamber of the engine according to one exemplary embodiment;

FIG. 3 is a flowchart showing a method of controlling ignition of the engine according to one exemplary embodiment;

FIG. 4 is a flowchart showing a technique to calculate a voltage of electrical power to be applied to an ignition source according to one exemplary embodiment;

FIG. 5 is a graph showing a variance of a voltage between an upper bound and a lower bound based on an exhaust gas recirculation error according to one exemplary embodiment;

FIG. 6 is a flowchart showing a technique to calculate a number of pre-primary ignitions to be applied to an ignition source according to one exemplary embodiment;

FIG. 7 is a graph showing a variance of number of pre-primary ignitions between an upper bound and a lower bound based on an exhaust gas recirculation error according to one exemplary embodiment;

FIG. 8 is a graph showing different heat release rates based on different voltages applied during pre-primary ignitions; and

FIG. 9 is a graph showing different heat release rates based on different numbers of pre-primary ignitions applied.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Referring to the Figures, wherein like numerals indicate like parts throughout the several views, a system 100 and a method 300 for controlling ignition in an engine 102 are shown and described herein.

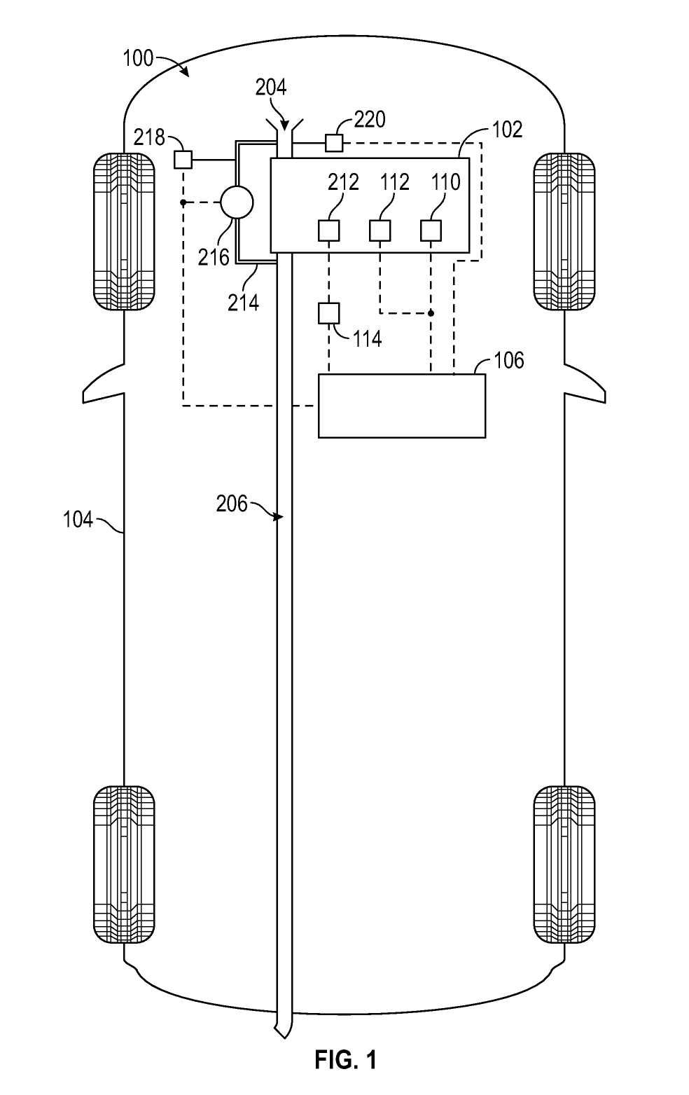

Referring to FIG. 1, the system 100 may be implemented in a vehicle 104 in one exemplary embodiment. In the exemplary embodiment, the vehicle 104 may be an automobile (not separately numbered). However, it should be appreciated that the system 100 may be implemented in other vehicles 104, including, but not limited to, motorcycles, aircraft, locomotives, and boats. Furthermore, the system 100 shown and described herein may also be implemented in non-vehicle applications (not shown).

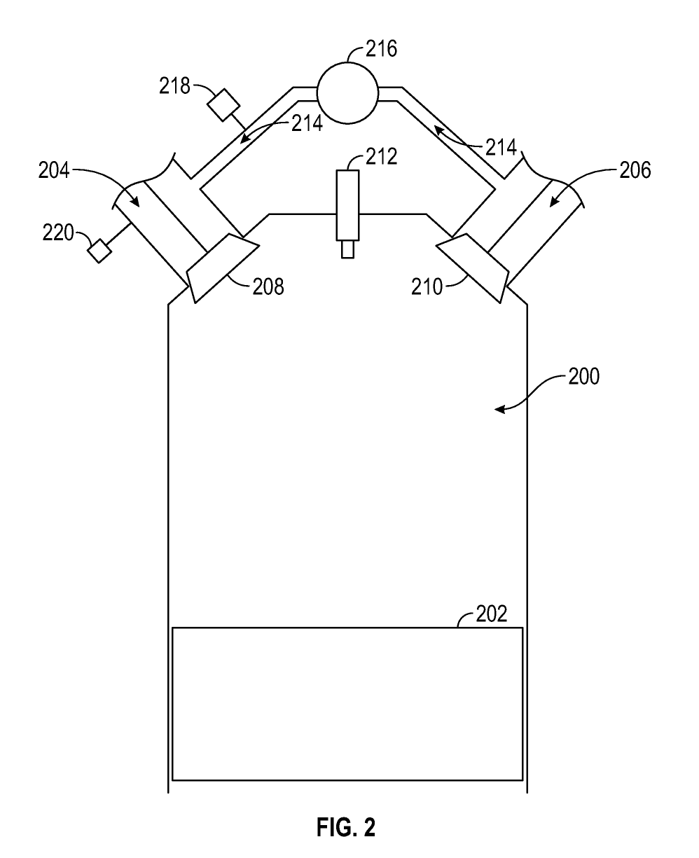

The engine 102 shown in the exemplary embodiments is an internal combustion engine (not separately numbered). Referring to FIG. 2, the engine 102 includes at least one combustion chamber 200, commonly referred to as a cylinder. The engine 102 may include a plurality of combustion chambers 200 with a piston 202 configured to reciprocate in each combustion chamber 200, as is well known to those skilled in the art. Each piston 202 is coupled to a crankshaft (not shown) via a connecting rod (not shown), as is also well known to those skilled in the art. However, it should be appreciated that in other embodiments, the engine 102 may be configured differently.

In the exemplary embodiment, the combustion chamber 200 defines an inlet 204 and an outlet 206 as is appreciated by those skilled in the art. The inlet 204 provides for intake air and/or an air-fuel mixture to enter the combustion chamber 200 while the outlet 206 provides for exhaust gas to exit the combustion chamber 200. An inlet valve 208 is utilized to regulate the inlet 204 while an outlet valve 210 is utilized to regulate the outlet 206 as is also well appreciated by those skilled in the art.

The engine 102 further includes an ignition source 212 disposed in communication with each combustion chamber 200. The ignition source 212 is capable of initiating combustion in the combustion chamber 200. In one exemplary embodiment, the ignition source 212 may be implemented with a low temperature plasma ignition device (not separately numbered). The low temperature plasma ignition device may produce one or more plasma streams to ignite the air/fuel mixture in the combustion chamber 200.

The engine 102 also includes an exhaust recirculation passage 214 fluidly connecting the outlet 206 to the inlet 204. An exhaust recirculation valve 216 divides the exhaust recirculation passage 214 and is configured to control flow of exhaust gas from the outlet 206 to the inlet 204. As appreciated by those skilled in the art, an inlet manifold (not shown) and/or an exhaust manifold (not shown) may be implemented to fluidly connect a plurality of inlets 204 and/or a plurality of outlets 206, respectively. As such, the exhaust recirculation passage 214 may connect the inlet manifold to the outlet manifold.

Referring again to FIG. 1, the system 100 includes a controller 106. The controller 106 is configured and capable of performing mathematical calculations and executing instructions, i.e., running a program. The controller 106 may be implemented with one or more of a processor, microprocessor, microcontroller, application specific integrated circuit (“ASIC”), memory, storage device, analog-to-digital converter (“ADC”), etc., as is appreciated by those skilled in the art. The controller 106 of the exemplary embodiment may commonly be referred to as an engine control module (“ECM”).

The controller 106 is in communication with the exhaust recirculation valve 216 to control the amount of exhaust gas, e.g., the flow rate of the exhaust gas, that flows between the outlet 206 and the inlet 204. Accordingly, the controller 106 may control operation of the exhaust recirculation valve 216 according to a desired exhaust recirculation flow rate.

The system 100 may include a flow sensor 218 in communication with the controller 106. The flow sensor 218 senses a flow rate of exhaust gas through the exhaust recirculation passage 214. The flow sensor 218 may measure differential pressure through an orifice having a known diameter, may be a mass flow meter, or any other sensing device capable of sensing a flow rate and/or an amount of fluid passing through the exhaust recirculation passage 214.

The system may further include an oxygen sensor 220 in communication with the controller 106. The oxygen sensor 220 is configured to sense the concentration of oxygen flowing through the inlet 204. The concentration of oxygen may be utilized to predict an amount of exhaust gas being supplied by the exhaust recirculation valve 216.

The system 100 may also include a speed sensor 110 in communication with the controller 106. The speed sensor 110 is configured to sense the rotational speed of the engine 102. In one embodiment, the speed sensor 110 measures the rotation speed of a crankshaft (not shown) and, thus, an output shaft (not shown) of the engine 102, as is readily appreciated by those skilled in the art.

The system 100 may further include a throttle position sensor 112 in communication with the controller 106. The throttle position sensor 112 is configured to sense a throttle position of the engine 102, i.e., the desired amount of air and fuel that is sent to the at least one combustion chamber 200 of the engine 102.

As such, in accordance with the above, the controller 106 may access data corresponding to the flow rate of exhaust gas through the exhaust recirculation passage 214, the rotational speed of the engine 102, and/or the throttle position of the engine 102.

The controller 106 may also determine and/or receive a combustion mode of the engine 102. The combustion mode may determine various operational parameters of the engine 102. In some embodiments, the combustion modes may include, but are not limited to, lean burn, stoichiometric, and full power output.

The controller 106 of the exemplary embodiments is configured to compute an exhaust gas recirculation error. In one exemplary embodiment, the exhaust gas recirculation error is based on the desired flow rate of recirculated exhaust gas and the sensed flow rate of recirculated exhaust gas. More specifically, the exhaust gas recirculation error is calculated by subtracting the sensed flow rate from the desired flow rate (or vice-versa). In another exemplary embodiment, exhaust gas recirculation error is based on the desired oxygen concentration of the inlet 204 and the measured oxygen concentration of the inlet 204. More specifically, the exhaust gas recirculation error is calculated by subtracting the measured oxygen concentration from the desired oxygen concentration (or vice-versa).”

The exhaust gas recirculation error may be converted into a simplified value that may be used as a control signal, as is appreciated by those skilled in the art. For instance, the exhaust gas recirculation error may be converted into a real number bounded by 0 and 1. The control signal may then present a unique voltage and/or current corresponding to the real number.

The system 100 may further include a power regulating circuit 114. The power regulating circuit 114 is in communication with the controller 106 and electrically connected to the ignition source 212. The power regulating circuit 114 may also be electrically connected to a power supply (not shown), e.g., a battery of the vehicle 104, to receive electrical power. The power regulating circuit 114 is configured to apply electrical power at a desired voltage to the ignition source 212 to initiate ignition and, thus, combustion within the combustion chamber 200.

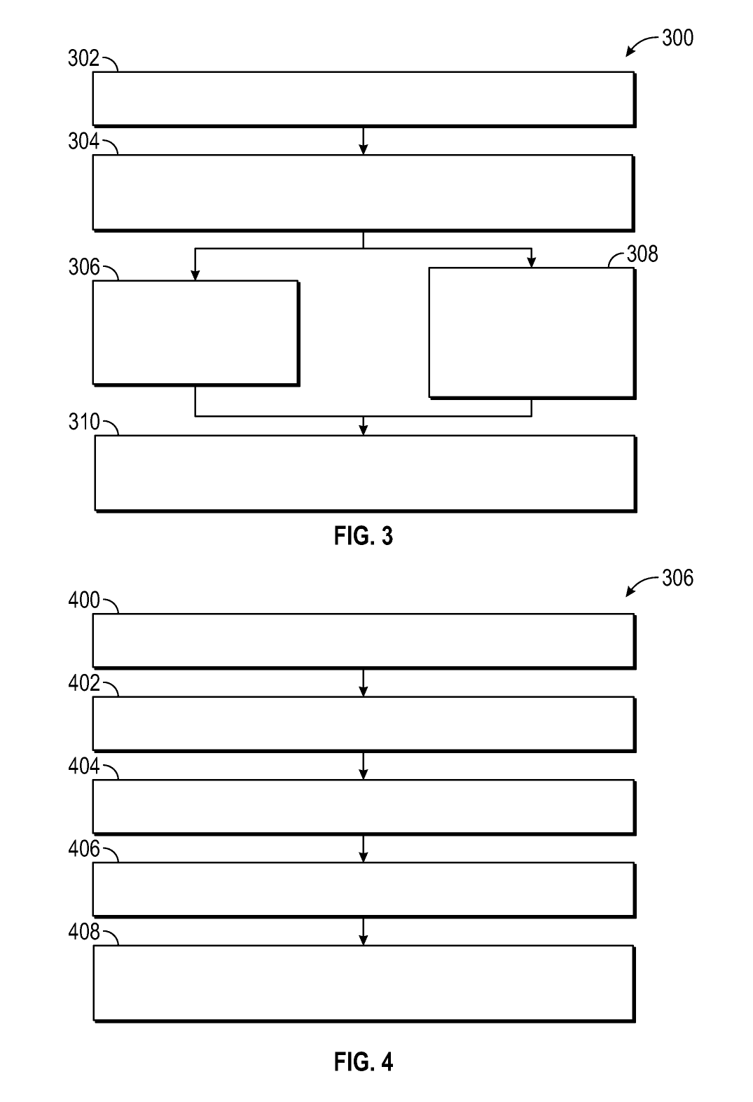

Referring now to FIG. 3, in an exemplary embodiment, the method 300 of controlling ignition of the engine 102 may utilize the system 100 and controller 106 described above. However, it should be appreciated that other systems, controllers, apparatus, and/or devices may be utilized to perform the methods 300 described herein.

The method 300 includes, at 302, accessing data corresponding to the exhaust gas recirculation error. The data corresponding to the exhaust gas recirculation error may be computed by the controller 106, as described above, or otherwise received by the controller 106, e.g., from another processor (not shown) and/or data source (not shown).

The method 300 also includes, at 304, accessing data corresponding to at least one of a rotational speed of the engine 102, a fuel mass quantity injected into the combustion chamber 200, a throttle position of a throttle, and a combustion mode of the engine 102. The data may be computed by the controller 106 or otherwise received by the controller 106.

The method 300 further includes, at 306, calculating a voltage of the electrical power to be applied to the ignition source 212. The calculated voltage is based on the data corresponding to the exhaust gas recirculation error and the data corresponding to at least one of the rotational speed of the engine 102, the fuel mass quantity injected into the combustion chamber 200, the throttle position, and the combustion mode of the engine 102. Said another way, the calculated voltage is based on the exhaust gas recirculation error and the rotation speed of the engine 102, the fuel mass quantity injected into the combustion chamber 200, the throttle position, and/or the combustion mode of the engine 102.

In the exemplary embodiment shown in FIG. 4, calculating the voltage of the electrical power to be applied to the ignition source 212 includes, at 400, calculating a nominal voltage based on the rotational speed of the engine 102 and the throttle position. The nominal voltage may be developed during a calibration process including injection timing, ignition timing, etc.

Calculating the voltage of the electrical power also includes, at 402, calculating an upper bound voltage based on a predetermined potential parasitic loss added to the nominal voltage. Calculating the voltage of the electrical power further includes, at 404, calculating a lower bound voltage based on the predetermined potential parasitic loss subtracted from the nominal voltage. The predetermined potential parasitic loss may be stored in the memory of the controller 106.

Calculating the voltage of the electrical power to be applied to the ignition source 212 may further include, at 406, modifying the lower bound voltage based on the combustion mode. That is, the lower bound voltage may be adjusted up or down based on the specific operating mode of the engine 102. In one example, the pre-determined upper bound voltage is 65 V while the pre-determined lower bound voltage is 15 V.

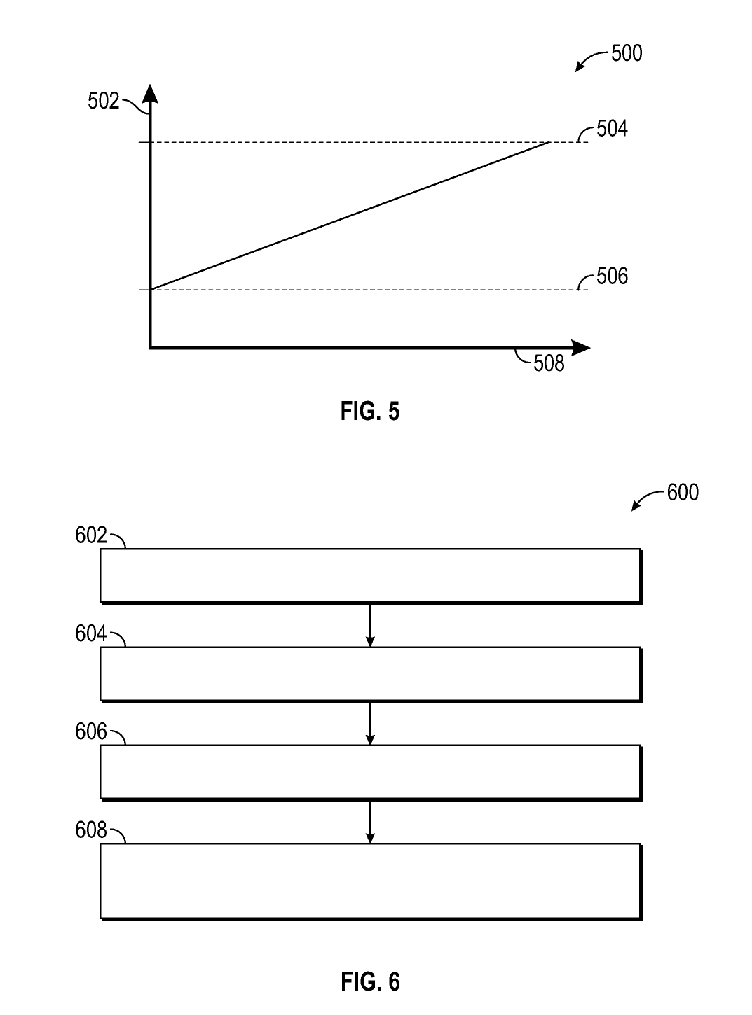

Calculating the voltage of the electrical power may further include, at 408, selecting a voltage between the upper bound voltage and the lower bound voltage based on the exhaust gas recirculation error. This selected voltage then becomes voltage of the electrical power to be applied to the ignition source. FIG. 5 shows a graph 500 giving one example of the variance of the voltage, represented by the vertical axis 502, between the upper bound voltage, represented by line 504, and lower bound voltage, represented by line 506, based on the exhaust gas recirculation error, represented by the horizontal axis 508.

Referring again to FIG. 3, the method 300 according to one exemplary embodiment may include, at 308, calculating a number of pre-primary ignitions to be applied based on the exhaust gas recirculation error. Pre-primary ignitions may be alternatively referred to as “pre-strikes” or “pre-sparks” and are ignitions that occur in the combustion chamber 200 prior to a main or primary ignition.

One exemplary technique 600 for calculating the number of pre-primary ignitions is shown in FIG. 6. This exemplary technique 600 includes, at 602, accessing a pre-determined upper bound number of pre-primary ignitions, and at 604, accessing a pre-determined lower bound number of pre-primary ignitions. These upper and lower bound numbers may be determined by testing of the engine 102 and stored in the controller 106 or other memory and/or storage location. In one example, the pre-determined upper bound number of pre-primary ignitions is 4 while the pre-determined lower bound number of pre-primary ignitions is 0.

Calculating the number of pre-primary ignitions may further include, at 606, modifying the lower bound number of pre-primary ignitions based on the combustion mode. For example, the lower bound number of pre-primary ignitions may be reduced from 1 to 0 based on the particular combustion mode of the engine 102. Of course, other modifications of the lower bound may be contemplated based on testing of the engine 102.

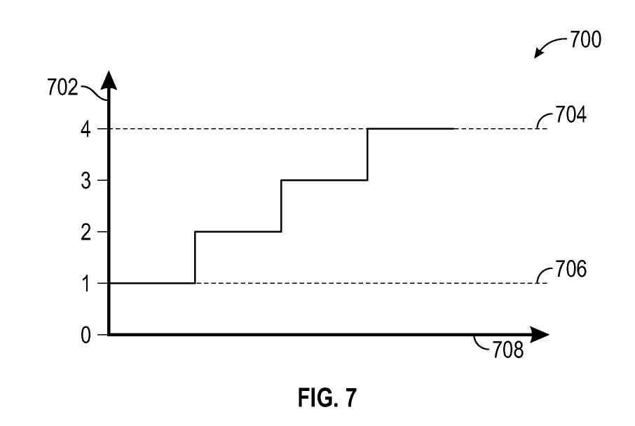

Calculating the number of pre-primary ignitions also includes, at 608, selecting a number between the upper bound number and the lower bound number based on the exhaust gas recirculation error. This selected number then becomes number of pre-primary ignitions to be applied to the ignition source 212. FIG. 7 shows a graph 700 giving one example of the variance of the number of pre-primary ignitions, represented by the vertical axis 702, between the upper bound number, represented by line 704, and the lower bound number, represented by line 706, based on the exhaust gas recirculation error, represented by the horizontal axis 708.

Referring again to FIG. 3, the method 300 according to one exemplary embodiment includes, at 310, applying electrical power at the calculated voltage to the ignition source 212 and in accordance with the calculated number of pre-primary ignitions to produce a pre-primary ignition.

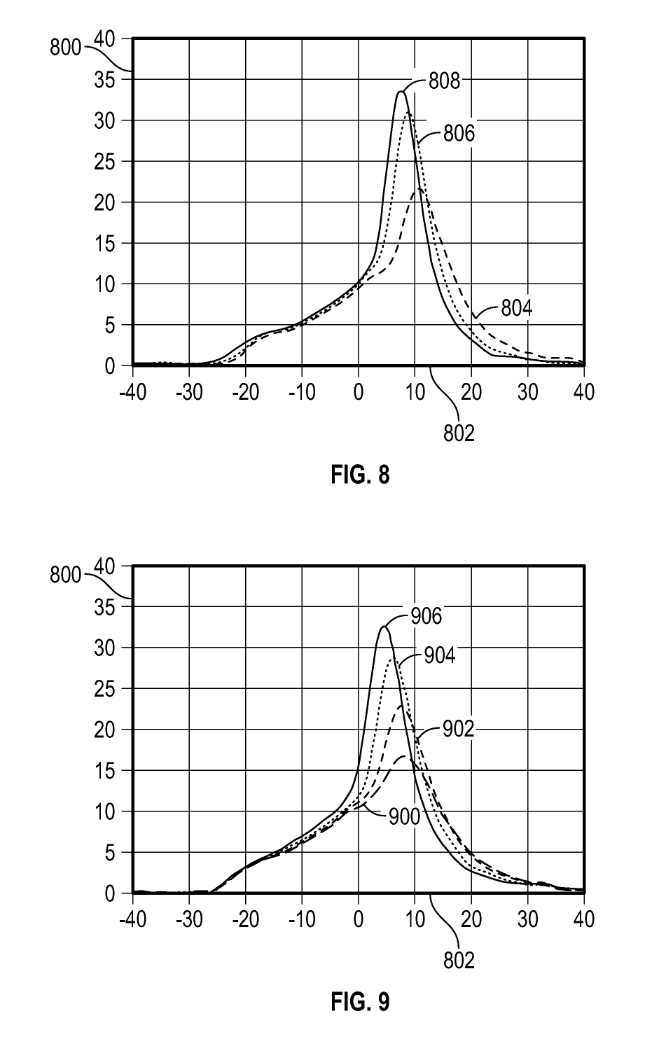

Varying the voltage applied to the ignition source 212 can alter the heat release rate (“HRR”) achieved in the combustion chamber 200. For instance, FIG. 8 illustrates HRR, represented by the vertical axis 800 in Joules per crank angle degree (“J/CAD”), versus crank angle, represented by the horizontal axis 802 in degrees after top dead center (“dATDC”). Curve 804 represents the relationship between HRR and crank angle when no pre-ignitions are performed. Curve 806 represents the relationship between HRR and crank angle when pre-ignitions at 40 V are performed. Curve 808 represents the relationship between HRR and crank angle when pre-ignitions at 50 V are performed. As can be seen, under certain conditions, increasing the voltage of the pre-ignitions has the effect of raising the HRR and moving the HRR toward 0 dATDC.

Varying the number of pre-primary ignitions applied to the ignition source 212 can also alter the HRR achieved in the combustion chamber 200. For example, FIG. 9 illustrates HRR, represented by the vertical axis 800 in J/CAD, versus crank angle, represented by the horizontal axis 802 in dATDC. Curve 900 represents the relationship between HRR and crank angle when no pre-ignitions are performed. Curve 902 represents the relationship between HRR and crank angle when 2 pre-ignitions are performed. Similarly, curve 904 represents the relationship between HRR and crank angle when 3 pre-ignitions are performed and curve 906 represents the relationship between HRR and crank angle when 4 pre-ignitions are performed. As can be seen, under certain conditions, increasing the number of pre-ignitions also has the effect of raising the HRR and moving the HRR toward 0 dATDC.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. A method of controlling pre-primary ignition of an internal combustion engine with a controller, the engine having a combustion chamber and an ignition source for igniting fuel in the combustion chamber, the method comprising:
accessing data corresponding to an exhaust gas recirculation error;
accessing data corresponding to at least one of a rotational speed of the engine, a fuel mass quantity injected into the combustion chamber, a throttle position of a throttle, and a combustion mode of the engine;
calculating a voltage of the electrical power to be applied to the ignition source based on the data corresponding to the exhaust gas recirculation error and the data corresponding to at least one of the rotational speed of the engine, the fuel mass quantity injected into the combustion chamber, the throttle position, and the combustion mode of the engine; and
applying electrical power at the calculated voltage to the ignition source to produce at least one pre-primary ignition.

2. The method as set forth in claim 1 wherein calculating a voltage of the electrical power to be applied to the ignition source comprises:
calculating a nominal voltage based on the rotational speed of the engine, the fuel mass injected into the combustion chamber, and the throttle position;
calculating an upper bound voltage based on a predetermined potential parasitic loss added to the nominal voltage;
calculating a lower bound voltage based on the predetermined potential parasitic loss subtracted from the nominal voltage; and
selecting a voltage between the upper bound voltage and the lower bound voltage based on the exhaust gas recirculation error as the voltage of the electrical power to be applied to the ignition source.

3. The method as set forth in claim 2 wherein calculating a voltage of the electrical power to be applied to the ignition source further comprises modifying the lower bound voltage based on the combustion mode.

4. The method as set forth in claim 1 further comprising calculating a number of pre-primary ignitions to be applied based on the exhaust gas recirculation error.

5. The method as set forth in claim 4 further comprising applying electrical power to the ignition source in accordance with the calculated number of pre-primary ignitions.

6. The method as set forth in claim 4 wherein calculating the number of pre-primary ignitions comprises:
accessing a pre-determined upper bound number of pre-primary ignitions;
accessing a pre-determined lower bound number of pre-primary ignitions; and
selecting a number between the upper bound number and the lower bound number based on the exhaust gas recirculation error as the number of pre-primary ignitions to be applied to the ignition source.

7. The method as set forth in claim 6 further comprising applying electrical power to the ignition source in accordance with the selected number of pre-primary ignitions to be applied.

8. The method as set forth in claim 7 further comprising increasing the voltage of the pre-ignitions to move a crank angle toward zero degrees after top dead center.

9. A method of controlling pre-primary ignition of an internal combustion engine with a controller, the engine having a combustion chamber and an ignition source for igniting fuel in the combustion chamber, the method comprising:
accessing data corresponding to an exhaust gas recirculation error;
accessing data corresponding to at least one of a rotational speed of the engine, a fuel mass injected into the combustion chamber, a throttle position of a throttle, and a combustion mode of the engine;
calculating a number of pre-primary ignitions to be applied based on the exhaust gas recirculation error; and
applying electrical power to the ignition source in accordance with the number of pre-primary ignitions to be applied.

10. The method as set forth in claim 9 wherein calculating the number of pre-primary ignitions comprises:
accessing a pre-determined upper bound number of pre-primary ignitions;
accessing a pre-determined lower bound number of pre-primary ignitions; and
selecting a number between the upper bound number and the lower bound number based on the exhaust gas recirculation error as the number of pre-primary ignitions to be applied to the ignition source.

11. The method as set forth in claim 9 further comprising calculating a voltage of the electrical power to be applied to the ignition source based on the data corresponding to the exhaust gas recirculation error and the data corresponding to at least one of the rotational speed of the engine, a fuel mass injected into the combustion chamber, the throttle position, and the combustion mode of the engine.

12. The method as set forth in claim 11 applying electrical power at the calculated voltage to the ignition source to produce a pre-primary ignition.

13. A vehicle comprising:
an engine including:
a combustion chamber defining an inlet and an outlet;
an ignition source for initiating pre-primary ignition in the combustion chamber;
an exhaust recirculation passage fluidly connecting the outlet to the inlet with an exhaust recirculation valve for controlling flow of exhaust gas from the outlet to the inlet;
a flow sensor for sensing a flow rate of exhaust gas through the exhaust recirculation passage;
a speed sensor for sensing the rotational speed of the engine; and
a throttle position sensor for sensing a throttle position of the engine;
a controller in communication with the sensors for receiving data corresponding to the flow rate of exhaust gas through the exhaust recirculation passage, the rotational speed of the engine, and the throttle position of the engine;
wherein the controller is in communication with the exhaust recirculation valve to control operation of the exhaust recirculation valve according to a desired exhaust recirculation flow rate;
the controller being configured to compute an exhaust gas recirculation error based on the desired exhaust recirculation flow rate and the sensed flow rate of exhaust gas;
the controller being configured to access the combustion mode of the engine;
the controller being configured to calculate a voltage of the electrical power to be applied to the ignition source based on the data corresponding to the exhaust gas recirculation error and the data corresponding to at least one of the rotational speed of the engine, a fuel mass injected into the combustion chamber, the throttle position, and the combustion mode of the engine; and
a power regulating circuit in communication with the controller and electrically connected to the ignition source and configured to apply electrical power at the calculated voltage to the ignition source to produce a primary ignition.

14. The vehicle as set forth in claim 13 wherein the controller is configured to calculate a number of pre-primary ignitions to be applied based on the exhaust gas recirculation error.

15. The vehicle as set forth in claim 14 wherein the power regulating circuit is further configured to apply electrical power to the ignition source in accordance with the calculated number of pre-primary ignitions.

16. The vehicle as set forth in claim 15 wherein the voltage of the pre-ignitions is increased to move a crank angle toward zero degrees after top dead center.

17. The vehicle as set forth in claim 14 wherein the controller is configured to calculate the number of pre-primary ignitions comprises the controller configured to :
access a pre-determined upper bound number of pre-primary ignitions;
access a pre-determined lower bound number of pre-primary ignitions; and
select a number between the upper bound number and the lower bound number based on the exhaust gas recirculation error as the number of pre-primary ignitions to be applied to the ignition source.

18. The vehicle as set forth in claim 17 wherein electrical power is applied to the ignition source in accordance with the selected number of pre-primary ignitions to be applied.

19. The vehicle as set forth in claim 13 wherein the controller being configured to calculate a voltage of the electrical power to be applied to the ignition source comprises the controller configured to:
calculate a nominal voltage based on the rotational speed of the engine, the fuel mass injected into the combustion chamber, and the throttle position;
calculate an upper bound voltage based on a predetermined potential parasitic loss added to the nominal voltage;
calculate a lower bound voltage based on the predetermined potential parasitic loss subtracted from the nominal voltage; and
select a voltage between the upper bound voltage and the lower bound voltage based on the exhaust gas recirculation error as the voltage of the electrical power to be applied to the ignition source.

20. The vehicle as set forth in claim 19 wherein the controller being configured to calculate a voltage of the electrical power to be applied to the ignition source further comprises the controller configured to modify the lower bound voltage based on the combustion mode.
